(19) United States
(12) Patent Application Publication
(10) Pub. No.: US 2003/0171994 A1
(43) Pub. Date: Sep. 11, 2003

(54) System for faciliating internet purchase/sales transactions without disclosing customer's identity, financial and contact data to merchant

(76) Inventors: Douglas B. Walter, Cumming, GA (US); Christian Nehammer, Estero, FL (US)

Correspondence Address: DOUG WALTER, 6725 CHELSEA GARDENS WAY, CUMMING, GA, 30040, US

(21) Appl. No.: 10/091,309

(22) Filed: Mar. 5, 2002

(51) Int. Cl. G06F 17/60

(52) U.S. Cl. 705/26

(57) ABSTRACT

A method is provided for conducting a purchase/sales transaction over a computer network (such as the Internet) where the customer remains anonymous to the merchant. The invention belongs to the category of Internet related purchase/sales transactions with several remote computers involved.

### CROSS REFERENCE TO

U.S. patent application Ser. No. 20010039517

U.S. patent application Ser. No. 20010037312

U.S. patent application Ser. No. 20020016749

U.S. patent application Ser. No. 20010027441

### BACKGROUND OF THE INVENTION

The process of purchasing merchandise over the Internet often requires customers to provide their credit card information, shipping address, e-mail address and telephone number in order to facilitate payment and delivery of the merchandise purchased.

However, customers may be hesitant to provide such personal information due to a concern that it could possibly be used for credit card fraud, identity theft, internal marketing campaigns, or even sold to third parties compiling mailing lists.

The accelerating complexity of data networks has severely restricted the ability of individuals to monitor and control the use of their personal information once disclosed. As a result, protection of confidential information has become an increasingly important issue—an issue that presents a barrier to Internet purchasing.

Offering a means by which credit card and contact information are only disclosed to a secure third party facilitator (rather than to the seller/merchant) will alleviate much of the privacy concern associated with purchasing merchandise via the Internet, thereby increasing Internet sales industry wide.

### BRIEF SUMMARY OF THE INVENTION

The Invention, (the “AIP System”) provides a method for customers to purchase merchandise via the Internet without disclosing their name, credit card information, shipping address, e-mail address or telephone number to the merchant. Once the customer and merchant agree to a transaction, the customer provides credit card and shipping information to a third party (“AIP Facilitator”) via encrypted server lines. The AIP Facilitator is responsible for coordinating the credit card payment and delivery of merchandise. Optionally, software enabling access to the AIP System can be stored on a mini compact disk. These CDs will be distributed to the public, providing exclusivity and an extra level of perceived security.

[image]

### AIP SYSTEM—Flow Chart Narrative

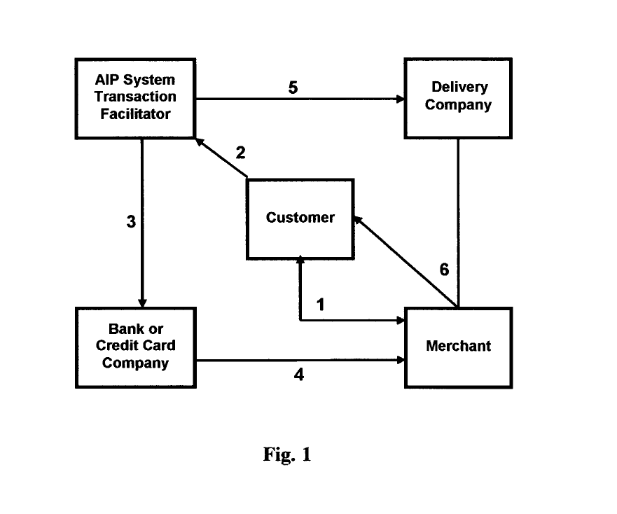

The following steps correspond with the arrows in FIG. 1.

Step 1: Customer identifies merchandise to purchase via the Internet. Merchant confirms on-line that such merchandise is in stock or readily available.

Step 2: Customer authorizes the AIP Facilitator to process the order, while providing specific payment and delivery instructions. Merchant identity and contact information, as well as the merchandise description and price, are automatically incorporated in the order request. This general function of the AIP System is currently offered by such companies as PayPal and BillPoint and is not a part of the present patent claim.

Step 3: The AIP Facilitator generates a 12-digit Order ID#. This Order ID# is sent to the Merchant, Customer, and Bank as a confirmation/tracking number. The Bank is instructed to process payment to the Merchant. This general function of the AIP System is currently offered by such companies as PayPal and BillPoint and is not a part of the present patent claim.

Step 4: The Bank pays Merchant and debits Customer's account. Once payment has been processed, Bank sends confirmation of such to the AIP Facilitator.

Step 5: The AIP Facilitator instructs the Delivery Company to deliver the merchandise. Delivery Company is provided with the Merchant's address, the Customer's address and the Order ID#.

Step 6: Delivery Company picks up merchandise from Merchant and delivers it to the shipping address corresponding with the Order ID#. If shipping charges were included in the cost of merchandise, Merchant pays Delivery Company through its established account. Otherwise, the merchandise is delivered to the Customer on a C.O.D. basis. Customer provides the Order# to Delivery Company, which serves as authorization to receive the merchandise.

As a result, payment is made and merchandise is delivered without disclosing the Customer's identity, financial or contact information to the Merchant. In the event the merchandise must be returned, the Order ID# is used for reference.

We claim:

1. A method to perform a secure purchase/sales transaction over a computer related network such as the Internet without requiring customers to provide their name, credit card details, shipping address, e-mail address or phone number to the merchant—whereby the customer authorizes a transaction facilitator to process the purchase/sale by placing the order with the subject merchant; submitting a request that the subject bank pay the merchant from the customer's account; and coordinating delivery of the purchased merchandise to the customer.

2. The method of claim 1, but additionally compromised by incorporating the entire Anonymous Internet Purchase (AIP) System into a computer related network such as the Internet, and web page that is part of any merchant's website.

3. The method of claim 1, but additionally compromised by incorporating the entire Anonymous Internet Purchase (AIP) System into a computer related network such as the Internet, and a web page that is part of any financial transaction company's website.

4. The method of claim 1, but additionally compromised by incorporating the entire Anonymous Internet Purchase (AIP) System into a computer related network, such as the Internet, and a web page other than any merchant's or any financial transaction company's website.

5. The method of claim 1, but additionally compromised by incorporating the entire Anonymous Internet Purchase (AIP) System into the content of a marketing/display system, burned on a compact disk in any available format.
